(19) United States
(12) Patent Application Publication
(10) Pub. No.: US 2025/0293542 A1
(43) Pub. Date: Sep. 18, 2025

(54) SYSTEMS AND METHODS FOR UTILIZING A MACHINE LEARNING MODEL TO PROTECT A DATA CENTER DURING AN ENVIRONMENTAL FAILURE

(71) Applicant: Verizon Patent and Licensing Inc., Basking Ridge, NJ (US)

(72) Inventors: Anthony Clay REYNOLDS, Rhome, TX (US); Suzanne B. SCHNAARS, Waldwick, NJ (US)

(73) Assignee: Verizon Patent and Licensing Inc., Basking Ridge, NJ (US)

(21) Appl. No.: 18/602,280

(22) Filed: Mar. 12, 2024

(51) Int. Cl. H02J 13/00; G06F 11/14

(52) U.S. Cl. CPC H02J 13/00002; G06F 11/1464; H02J 13/00004

(57) ABSTRACT

A device may receive data center data associated with a data center, and may receive external environmental data, (e.g., local weather data) associated with the data center. The device may train a machine learning model, with the data center data and the external environmental data, to generate a trained model, and may receive an indication of an environmental condition event associated with a data center. The device may process the indication of the environmental condition event, with the trained model, to identify applications and hardware to shut down to allow particular applications to remain online and to determine whether to move the particular applications to a redundant location. The device may cause the data center to shut down the applications and the hardware and/or to move the particular applications to a redundant location.

### BACKGROUND

A data center may include a physical facility that organizations use to house applications and data. A data center may include several components, such as network devices, storage systems, servers, application-delivery controllers, and/or the like.

### BRIEF DESCRIPTION OF THE DRAWINGS

FIGS. 1A-1F are diagrams of an example associated with utilizing a machine learning model to protect a data center during an environmental failure.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for utilizing a machine learning model to protect a data center during an environmental failure.

### DETAILED DESCRIPTION OF EXAMPLE EMBODIMENTS

The following detailed description of example implementations refers to the accompanying drawings. The same reference numbers in different drawings may identify the same or similar elements.

A data center is vulnerable to equipment and power failures, which can lead to overheating, system malfunctions, and potential loss of critical data. Current techniques for managing a data center often rely on manual interventions, which are labor-intensive and prone to human error. The lack of an automated, intelligent response mechanism in the current techniques may lead to suboptimal decisions, increased downtime, and potential data loss. Additionally, current techniques are unable to dynamically adjust operations for varying demand, power consumption, and environmental conditions, which leads to inefficiencies in energy usage and higher operational costs. Thus, current techniques for managing a data center consume computing resources (e.g., processing resources, memory resources, communication resources, and/or the like), networking resources, and/or other resources associated with implementing suboptimal changes to the data center, handling customer complaints due to increased downtime of the data center, handling lost data due data center malfunctions, failing to provide efficient energy usage by the data center, and/or the like.

Some implementations described herein relate to a control system that utilizes a machine learning model to protect a data center during an environmental failure. For example, the control system may receive data center data associated with a data center, and may receive external environmental data associated with the data center. The control system may train a machine learning model, with the data center data and the external environmental data, to generate a trained model, and may receive an indication of an environmental condition event associated with a data center. The control system may process the indication of the environmental condition event, with the trained model, to identify applications and hardware to shut down to allow particular applications to remain online and to determine whether to move the particular applications to a redundant location. The control system may cause the data center to shut down the applications and the hardware and/or to move the particular applications to a redundant location.

In this way, the control system utilizes a machine learning model to protect a data center during an environmental failure. For example, the control system may utilize the machine learning model to enhance resilience and efficiency of a data center controlled by the control system. The control system may monitor various conditions within the data center, and may receive an indication of a failure or a potential failure of the data center based on monitoring the conditions. In response to the failure of the data center, the control system may initiate an intelligent shutdown sequence, which includes shutting down non-critical components, migrating critical traffic to backup locations, and reducing power consumption. The control system may also monitor external environmental conditions, and may adjust the shutdown sequence based on the external environmental conditions. By implementing energy-saving measures and shutting down redundant applications, the control system may optimize power usage, reduce a risk of hardware damage and data loss, protect user plane data, and minimize energy consumption and operational costs. The control system may respond to potential failures in real time, which may enhance the reliability of data center operations and contribute to sustainability of the data center. Thus, the control system may conserve computing resources, networking resources, and/or other resources that would have otherwise been consumed by implementing suboptimal changes to the data center, handling customer complaints due to increased downtime of the data center, handling lost data due data center malfunctions, failing to provide efficient energy usage by the data center, and/or the like.

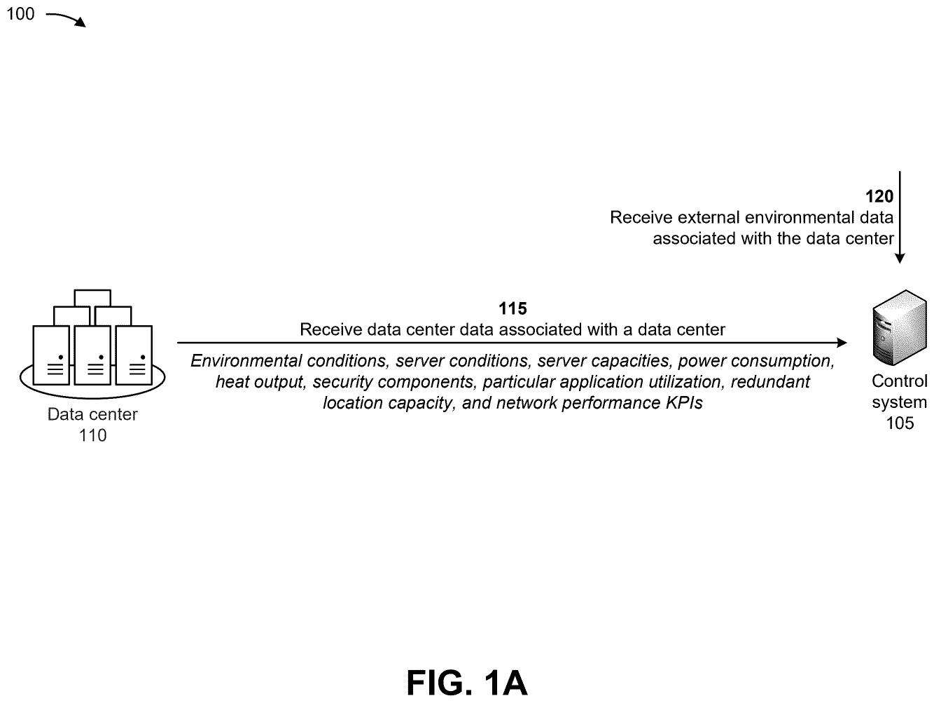

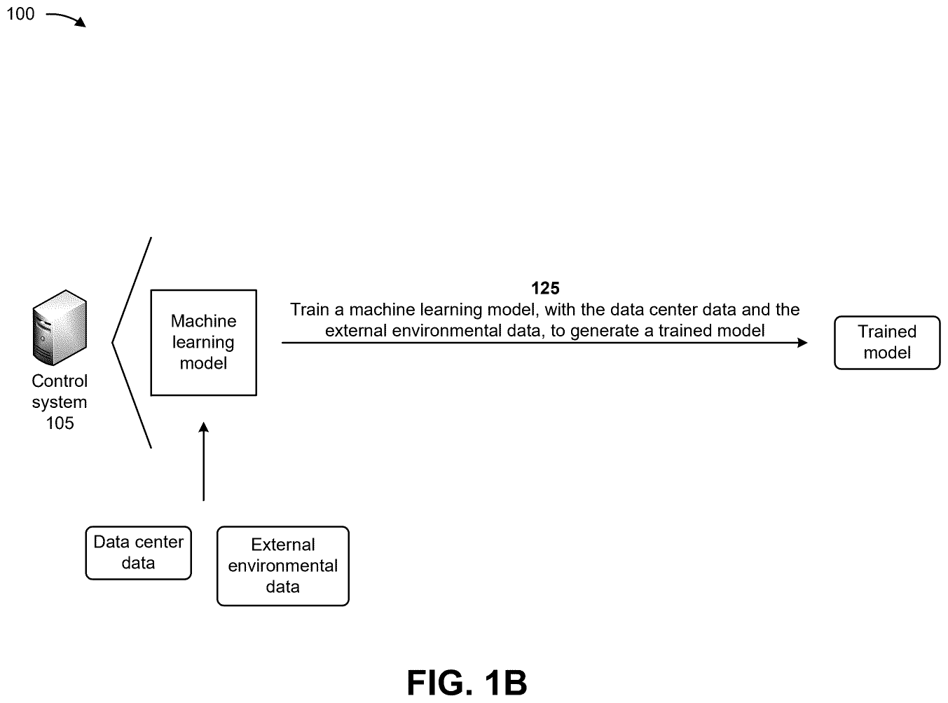

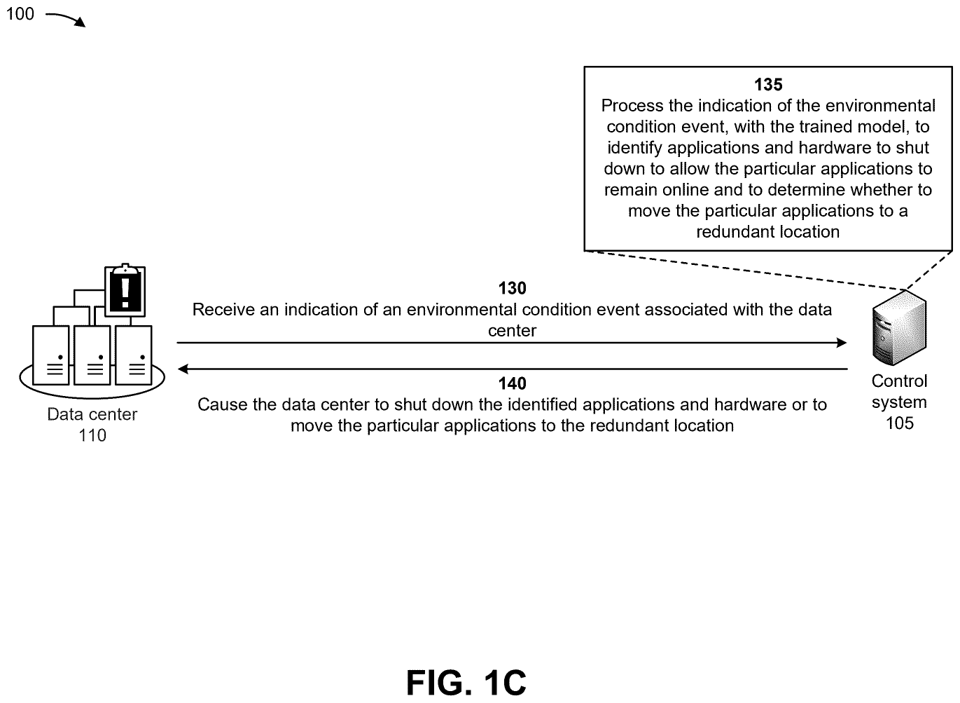

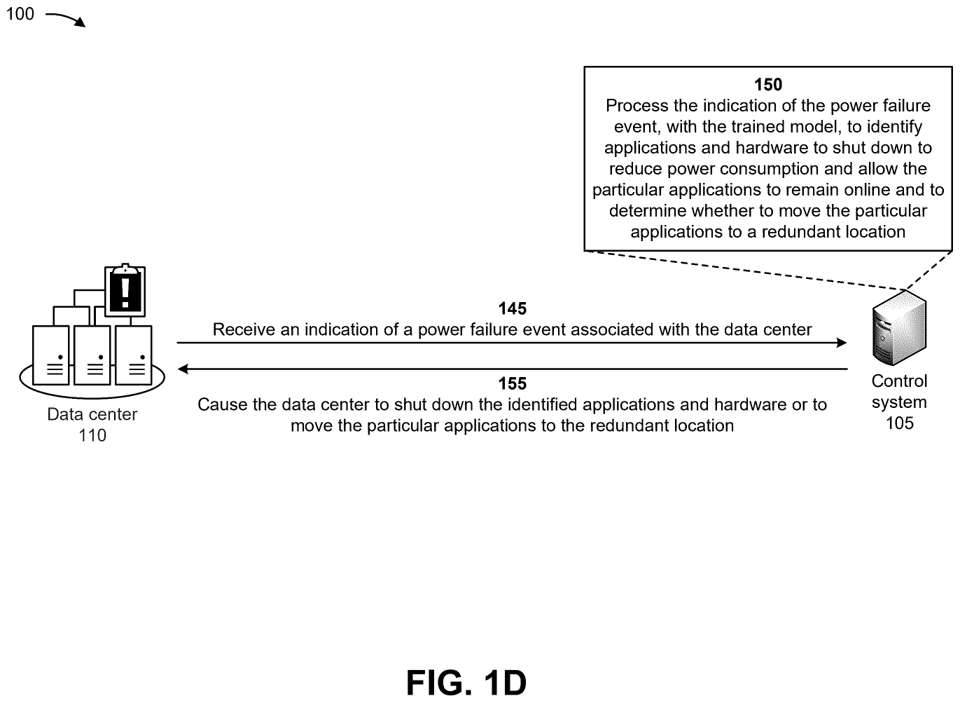

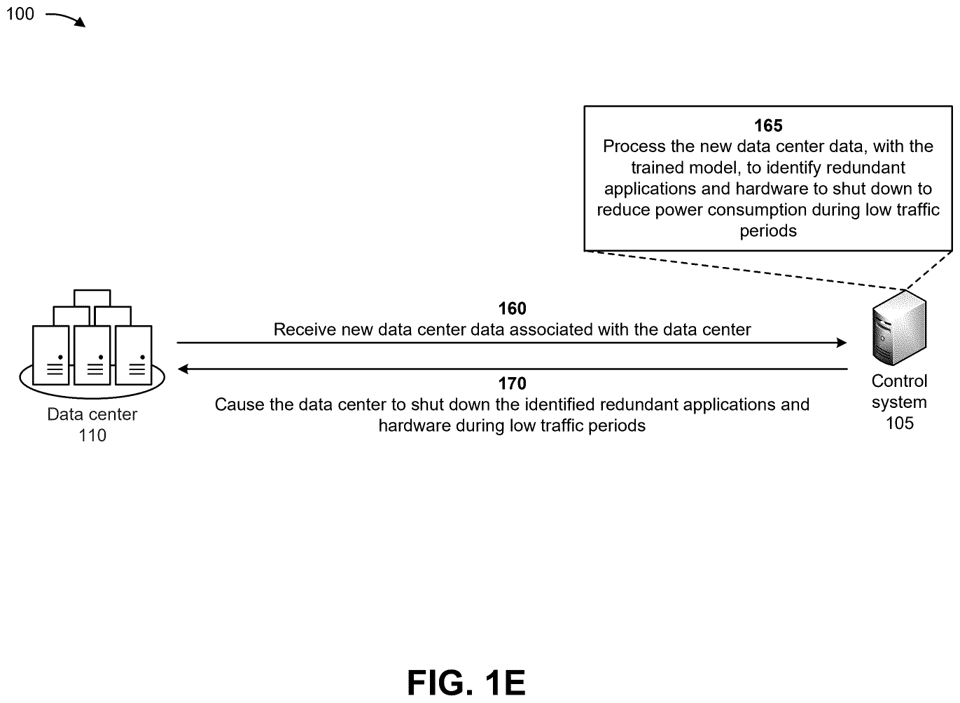

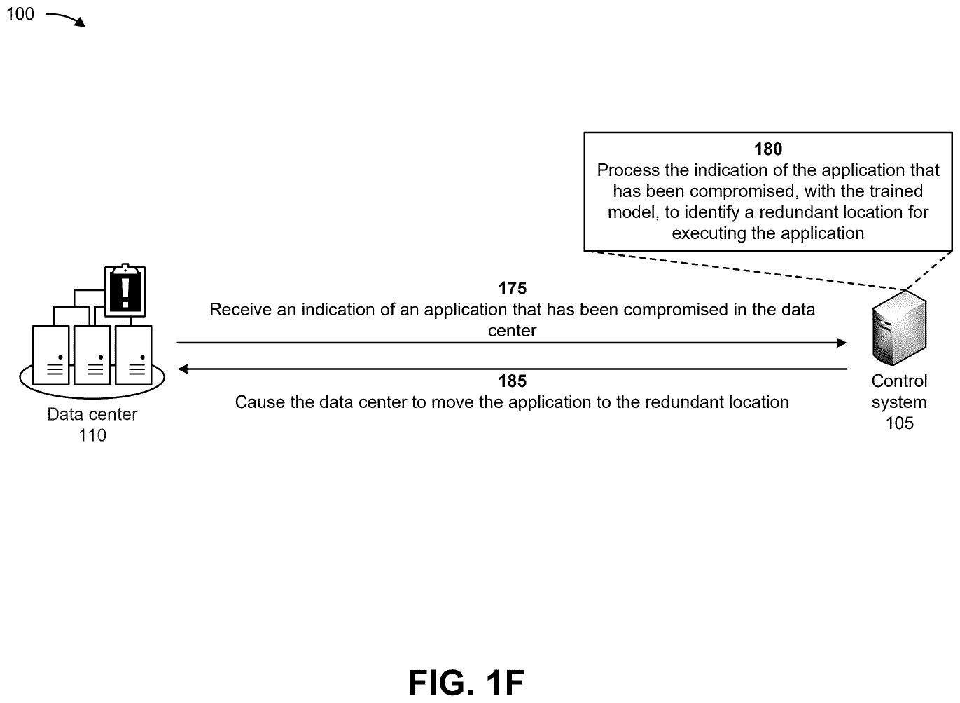

FIGS. 1A-1F are diagrams of an example 100 associated with utilizing a machine learning model to protect a data center during an environmental failure. As shown in FIGS. 1A-1F, the example 100 includes a control system 105 associated with a data center 110. The control system 105 may include a system that utilizes a machine learning model to protect a data center during an environmental failure. The data center 110 may include various types of equipment, including a complex of server racks with server devices and various environmental and power systems, such as heating, ventilation, and air conditioning (HVAC), power supply units, security systems, and/or the like. Further details of the control system 105 and the data center 110 are provided elsewhere herein.

Furthermore, although implementations are described herein as including a single control system 105 and a single data center 110, in some implementations, the control system 105 may be utilized with environments other than the data center 110 (e.g., environments with customer critical or non-critical data, such as with multiple data centers 110). In such implementations, a machine learning model described herein may be distributed at each data center 110 and a centralized machine learning model may be provided that learns from distributed machine learning models.

As shown in FIG. 1A, and by reference number 115, the control system 105 may receive data center data associated with the data center 110. For example, the data center 110 may include sensors that monitor performance parameters and conditions associated with the data center 110. In some implementations, the sensors may monitor environmental conditions of the data center 110 (e.g., temperature, humidity, air flow, and HVAC conditions); server conditions of the data center 110 (e.g., server temperatures, status, and/or the like); server capacities of the data center 110 (e.g., available capacities of servers, total capacities of servers, and/or the like); power consumption of the data center 110 (e.g., power consumption by servers, storage devices, network devices, environment systems, security systems, building systems, and/or the like); heat output of the data center 110 (e.g., heat output by servers, storage devices, network devices, environment systems, security systems, building systems, and/or the like); security components of the data center 110 (e.g., power consumption, heat output and status of security systems); particular application utilization by the data center 110 (e.g., utilization of customer-centric or critical applications); redundant location capacity (e.g., capacities of redundant or backup locations capable of executing the particular applications), and network performance key performance indicators (KPIs) of the data center 110 (e.g., KPIs measuring a performance and a functionality of a network, such as network device health, network availability, network throughput, network latency, network error rate, etc.); and/or the like.

Based on monitoring with the sensors, the data center 110 may generate the data center data associated with the data center 110. The data center data may include data identifying environmental conditions, server conditions, server capacities, power consumption, heat output, security components, particular application utilization, redundant location capacity, network performance KPIs, and/or the like associated with the data center 110. In some implementations, the control system 105 may continuously receive data center data from the data center 110, may periodically receive the data center data from the data center 110, may receive the data center data from the data center 110 based on requesting the data center data from the data center 110, and/or the like.

As further shown in FIG. 1A, and by reference number 120, the control system 105 may receive external environmental factors, such as external environmental data associated with the data center 110. For example, the external environmental data (e.g., local weather) of the data center 110 may impact performance of the data center due to potential and actual power outages caused by lightning or high winds, power outages caused by blizzards or ice, overheating of components of the data center 110 due to high temperatures or high humidity, and/or the like. Thus, the control system 105 may monitor local environmental factors (e.g., weather data) associated with the data center 110. The external environmental data may include data identifying temperatures, humidity, storms, trends, weather forecasts, and/or the like associated with the data center 110. In some implementations, the control system 105 may continuously receive the external environmental data from a third party (e.g., a weather bureau), may periodically receive the external environmental data from the third party, may receive the external environmental data from the third party based on requesting the external environmental data from the third party, and/or the like.

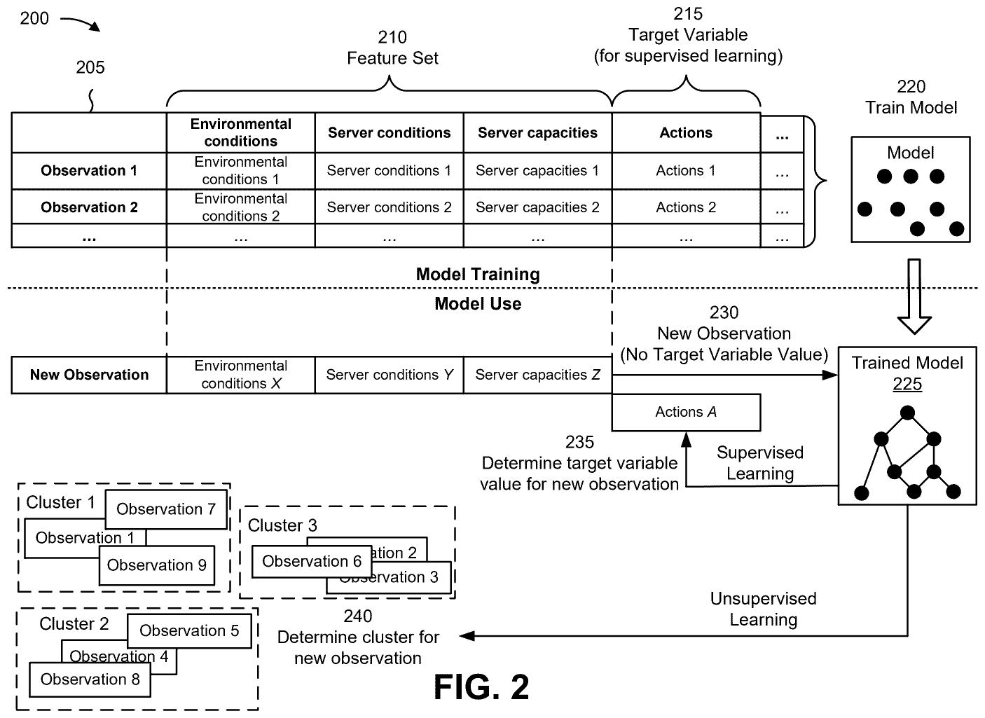

As shown in FIG. 1B, and by reference number 125, the control system 105 may train a machine learning model, with the data center data and the external environmental data, to generate a trained model. For example, the control system 105 may be associated with a machine learning model that may be trained with the data center data and the external environmental data. The trained machine learning model may be referred to as a trained model. The machine learning model may process the data center data and the external environmental data and may create trends based on processing the data center data and the external environmental data. Once the trained model is generated, the control system 105 may utilize the trained model to perform actions based on potential or actual power failures or environmental failures (e.g., loss of an HVAC system in the data center 110). Further details of the machine learning model and training the machine learning model are described below in connection with FIG. 2.

As shown in FIG. 1C, and by reference number 130, the control system 105 may receive an indication of an environmental condition event associated with the data center 110. For example, the data center 110 may experience an environmental condition event, such as an issue with HVAC at the data center 110, an issue with temperature at the data center 110, an issue with humidity at the data center 110, an issue with air flow at the data center 110, and/or the like. One or more sensors associated with the data center 110 may identify the environmental condition event and may generate an indication of the environmental condition event associated with the data center 110. The one or more sensors may provide the indication of the environmental condition event associated with the data center 110 to the control system 105, and the control system 105 may receive the indication of the environmental condition event associated with the data center 110 from the one or more sensors.

As further shown in FIG. 1C, and by reference number 135, the control system 105 may process the indication of the environmental condition event, with the trained model, to identify applications and hardware to shut down to allow the particular applications to remain online and to determine whether to move the particular applications to a redundant location. For example, the control system 105 may process the indication of the environmental condition event, with the trained model, to determine a shutdown sequence for the data center 110. In some implementations, the control system 105 may initiate the shutdown sequence for the data center 110 based on the indication of the environmental condition event. The shutdown sequence may include causing the data center 110 to shut down particular components (e.g., hardware, applications, and/or the like), migrate particular traffic to backup locations (e.g., redundant data centers 110), reduce power consumption, and/or the like. In some implementations, the control system 105 may identify the particular components of the data center 110 to shut down during the shutdown sequence, may identify the particular traffic to migrate to the backup locations during the shutdown sequence, may identify one or more servers of the data center 110 to deactivate during the shutdown sequence to reduce power consumption. In some implementations, the control system 105 may notify a system administrator about initiation of the shutdown sequence for the data center 110. In some implementations, the intelligent shutdown sequence may enable the data center 110 to conserve power and reduce heat loading.

In some implementations, the trained model may identify, based on the environmental condition event, applications and hardware to shut down at the data center 110 in order to allow the particular applications (e.g., customer-centric or critical applications) to remain online. In some implementations, the trained model may also determine, based on the environmental condition event, whether to move the particular applications to a redundant location (e.g., another data center 110). In this way, the control system 105 may begin the shutdown of applications, underlying software, and hardware that enable the particular applications to remain online. Additionally, the control system 105 may be aware of redundant data centers 110 and have the option to move critical traffic to the redundant data centers 110 due to the environmental condition event.

As further shown in FIG. 1C, and by reference number 140, the control system 105 may cause the data center 110 to shut down the identified applications and hardware or to move the particular applications to the redundant location. For example, based on initiation of the shutdown sequence and/or identification of the applications and hardware to shut down at the data center 110, the control system 105 may generate a command that instructs the data center 110 to shut down the identified applications and hardware. The control system 105 may provide the command to the data center 110, and the data center 110 may shut down the identified applications and hardware based on the command. Alternatively, or additionally, based on initiation of the shutdown sequence and/or identification of the applications and hardware to shut down at the data center 110, the control system 105 may generate another command that instructs the data center 110 to move the particular applications to the redundant location. The control system 105 may provide the other command to the data center 110, and the data center 110 may move the particular applications to the redundant location based on the other command.

As shown in FIG. 1D, and by reference number 145, the control system 105 may receive an indication of a power failure event associated with the data center 110. For example, the data center 110 may experience a power failure event, such as a commercial power failure at the data center 110, a power failure with one or more servers at the data center 110, a power failure with one or more control systems at the data center 110, and/or the like. One or more sensors associated with the data center 110 may identify the power failure event and may generate an indication of the power failure event associated with the data center 110. The one or more sensors may provide the indication of the power failure event associated with the data center 110 to the control system 105, and the control system 105 may receive the indication of the power failure event associated with the data center 110 from the one or more sensors.

As further shown in FIG. 1D, and by reference number 150, the control system 105 may process the indication of the power failure event, with the trained model, to identify applications and hardware to shut down to reduce power consumption and allow the particular applications to remain online and to determine whether to move the particular applications to a redundant location. For example, the control system 105 may process the indication of the power failure event, with the trained model, to determine a shutdown sequence for the data center 110. In some implementations, the control system 105 may initiate the shutdown sequence for the data center 110 based on the indication of the power failure event. The shutdown sequence may include causing the data center 110 to shut down particular components, migrate particular traffic to backup locations, reduce power consumption, and/or the like. In some implementations, the control system 105 may identify the particular components of the data center 110 to shut down during the shutdown sequence, may identify the particular traffic to migrate to the backup locations during the shutdown sequence, may identify one or more servers of the data center 110 to deactivate during the shutdown sequence to reduce power consumption. In some implementations, the control system 105 may notify a system administrator about initiation of the shutdown sequence for the data center 110. In some implementations, the intelligent shutdown sequence may enable the data center 110 to conserve power and reduce heat loading. In one example, when a commercial power failure occurs, the control system 105 determine the shutdown sequence based on historical power utilization, generator capacity, external temperatures, internal temperatures, and mean time to commercial power restoration associated with the data center 110.

In some implementations, the trained model may identify, based on the power failure event, applications and hardware to shut down at the data center 110 to reduce power consumption and to allow the particular applications (e.g., customer-centric or critical applications) to remain online. In some implementations, the trained model may also determine, based on the power failure event, whether to move the particular applications to a redundant location (e.g., another data center 110). In this way, the control system 105 may begin the shutdown of applications, underlying software, and hardware that enable the particular applications to remain online and reduce power consumption. Additionally, the control system 105 may be aware of redundant data centers 110 and have the option to move critical traffic to the redundant data centers 110 due to the power failure event.

As further shown in FIG. 1D, and by reference number 155, the control system 105 may cause the data center 110 to shut down the identified applications and hardware or to move the particular applications to the redundant location. For example, based on initiation of the shutdown sequence and/or identification of the applications and hardware to shut down at the data center 110, the control system 105 may generate a command that instructs the data center 110 to shut down the identified applications and hardware. The control system 105 may provide the command to the data center 110, and the data center 110 may shut down the identified applications and hardware based on the command. Alternatively, or additionally, based on initiation of the shutdown sequence and/or identification of the applications and hardware to shut down at the data center 110, the control system 105 may generate another command that instructs the data center 110 to move the particular applications to the redundant location. The control system 105 may provide the other command to the data center 110, and the data center 110 may move the particular applications to the redundant location based on the other command.

As shown in FIG. 1E, and by reference number 160, the control system 105 may receive new data center data associated with the data center 110. For example, after the machine learning model is trained, the control system 105 may continuously receive new data center data from the data center 110, may periodically receive new data center data from the data center 110, may receive new data center data from the data center 110 based on requesting the new data center data. The new data center data may include data identifying current environmental conditions, current server conditions, current server capacities, current power consumption, current heat output, current security components, current particular application utilization, current redundant location capacity, current network performance KPIs, and/or the like associated with the data center 110.

As further shown in FIG. 1E, and by reference number 165, the control system 105 may process the new data center data, with the trained model, to identify redundant applications and hardware to shut down to reduce power consumption during low traffic periods. For example, the control system 105 may process the new data center data, with the trained model, to reduce overall power utilization by the data center 110 based on shutting down redundant applications in lower traffic periods. In this way, the control system 105 may reduce overall utilities costs for the data center 110 and may reduce a carbon footprint of the data center 110. In some implementations, the trained model may identify, based on the new data center data, redundant applications and hardware to shut down at the data center 110 in order to reduce power consumption by the data center 110 during low traffic periods.

As further shown in FIG. 1E, and by reference number 170, the control system 105 may cause the data center 110 to shut down the identified redundant applications and hardware during low traffic periods. For example, based on identification of the redundant applications and hardware to shut down at the data center 110, the control system 105 may generate a command that instructs the data center 110 to shut down the redundant applications and hardware during low traffic periods. The control system 105 may provide the command to the data center 110, and the data center 110 may shut down the redundant applications and hardware during low traffic periods and based on the command.

As shown in FIG. 1F, and by reference number 175, the control system 105 may receive an indication of an application that has been compromised in the data center 110. For example, the data center 110 may experience an application that has been compromised (e.g., hacked or infected with a virus), hardware supporting the application that has been compromised (e.g., a corrupted memory device), and/or the like. A security system associated with the data center 110 may identify the application that has been compromised and may generate an indication of the compromised application. The security system may provide the indication of the compromised application to the control system 105, and the control system 105 may receive the indication of the compromised application from the security system.

As further shown in FIG. 1F, and by reference number 180, the control system 105 may process the indication of the application that has been compromised, with the trained model, to identify a redundant location for executing the application. For example, the control system 105 may process the indication of the application that has been compromised, with the trained model, to prevent the application from affecting other applications and/or hardware associated with the data center 110, to prevent loss of data at the data center, and/or the like. In some implementations, the trained model may identify, based on the indication of the compromised application, a redundant location (e.g., another data center 110) for executing the application.

As further shown in FIG. 1F, and by reference number 185, the control system 105 may cause the data center 110 to move the application to the redundant location. For example, based on identification of the redundant location (e.g., the other data center 110) for executing the application, the control system 105 may generate a command that instructs the data center 110 to move the application to the redundant location. The control system 105 may provide the command to the data center 110, and the data center 110 may move the application to the redundant location based on the command.

In some implementations, the control system 105 may utilize the trained model, with monitored data center data and/or external environmental data, to predict a potential failure (e.g., a power failure or an environmental control failure) at the data center 110. In some implementations, the control system 105 may simulate potential failure scenarios to train the machine learning model for predicting a potential failure at the data center 110. In some implementations, the control system 105 may continuously retrain the machine learning model based on new data center data and/or new external environmental data and to improve the accuracy of the trained model. In some implementations, the control system 105 may adjust the intelligent shutdown sequence for the data center 110 based on real-time analysis of network KPIs. In some implementations, the control system 105 may learn from historical intelligent shutdown sequences to optimize future responses to potential failures at the data center 110. In some implementations, the control system 105 may store data related to the intelligent shutdown sequence for compliance and analysis purposes.

In this way, the control system 105 utilizes a machine learning model to protect a data center 110 during an environmental failure. For example, the control system 105 may utilize the machine learning model to enhance resilience and efficiency of the data center 110 controlled by the control system 105. The control system may monitor various conditions within the data center 110, and may receive an indication of a failure or a potential failure of the data center 110 based on monitoring the conditions. In response to the failure of the data center 110, the control system 105 may initiate an intelligent shutdown sequence, which includes shutting down non-critical components, migrating critical traffic to backup locations, and reducing power consumption. The control system 105 may also monitor external environmental conditions, and may adjust the shutdown sequence based on the external environmental conditions. By implementing energy-saving measures and shutting down redundant applications, the control system 105 may optimize power usage, reduce a risk of hardware damage and data loss, protect user plane data, and minimize energy consumption and operational costs. The control system 105 may respond to potential failures in real time, which may enhance the reliability of data center operations and contribute to sustainability of the data center 110. Thus, the control system 105 may conserve computing resources, networking resources, and/or other resources that would have otherwise been consumed by implementing suboptimal changes to the data center 110, handling customer complaints due to increased downtime of the data center 110, handling lost data due data center malfunctions, failing to provide efficient energy usage by the data center 110, and/or the like.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

FIG. 2 is a diagram illustrating an example 200 of training and using a machine learning model. The machine learning model training and usage described herein may be performed using a machine learning system. The machine learning system may include or may be included in a computing device, a server, a cloud computing environment, or the like, such as the control system 105.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the control system 105, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the control system 105. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of environmental conditions, a second feature of server conditions, a third feature of server capacities, and so on. As shown, for a first observation, the first feature may have a value of environmental conditions 1, the second feature may have a value of server conditions 1, the third feature may have a value of server capacities 1, and so on. These features and feature values are provided as examples, and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is actions, which has a value of actions 1 for the first observation. The feature set and target variable described above are provided as examples, and other examples may differ from what is described above.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of environmental conditions X, a second feature of server conditions Y, a third feature of server capacities Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of actions A for the target variable of actions for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., an environmental conditions cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a server conditions cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model).

In this way, the machine learning system may apply a rigorous and automated process to predict actions by the data center 110 during environmental failure. The machine learning system may enable recognition and/or identification of tens, hundreds, thousands, or millions of features and/or feature values for tens, hundreds, thousands, or millions of observations, thereby increasing accuracy and consistency and reducing delay associated with predicting actions by the data center 110 during environmental failure relative to requiring computing resources to be allocated for tens, hundreds, or thousands of operators to manually predict actions by the data center 110 during environmental failure.

As indicated above, FIG. 2 is provided as an example. Other examples may differ from what is described in connection with FIG. 2.

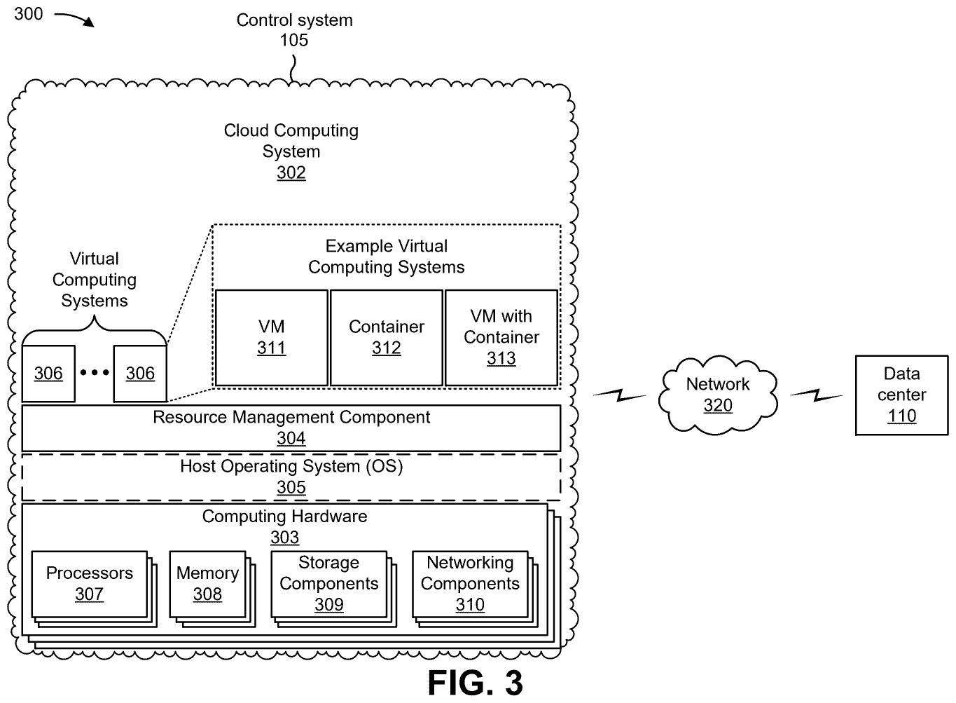

FIG. 3 is a diagram of an example environment 300 in which systems and/or methods described herein may be implemented. As shown in FIG. 3, the environment 300 may include the control system 105, which may include one or more elements of and/or may execute within a cloud computing system 302. The cloud computing system 302 may include one or more elements 303-313, as described in more detail below. As further shown in FIG. 3, the environment 300 may include the data center 110 and/or a network 320. Devices and/or elements of the environment 300 may interconnect via wired connections and/or wireless connections.

The data center 110 may include one or more devices capable of receiving, generating, storing, processing, and/or providing information, as described elsewhere herein. The data center 110 may include a physical facility that organizations use to house applications and data. A design of the data center 110 may be based on a network of computing and storage resources that enable delivery of shared applications and data. The data center 110 may include several components, such as network devices (e.g., routers, switches, firewalls, and/or the like), storage systems, servers, application-delivery controllers, and/or the like.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

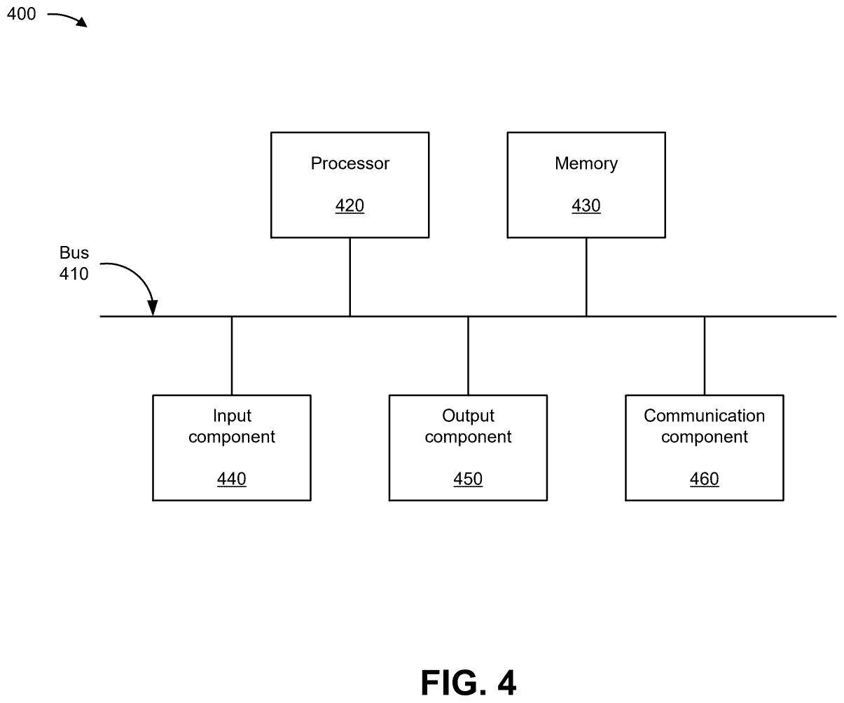

Although the control system 105 may include one or more elements 303-313 of the cloud computing system 302, may execute within the cloud computing system 302, and/or may be hosted within the cloud computing system 302, in some implementations, the control system 105 may not be cloud-based (e.g., may be implemented outside of a cloud computing system) or may be partially cloud-based. For example, the control system 105 may include one or more devices that are not part of the cloud computing system 302, such as a device 400 of FIG. 4, which may include a standalone server or another type of computing device. The control system 105 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the control system 105 and/or the data center 110. In some implementations, the control system 105 and/or the data center 110 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

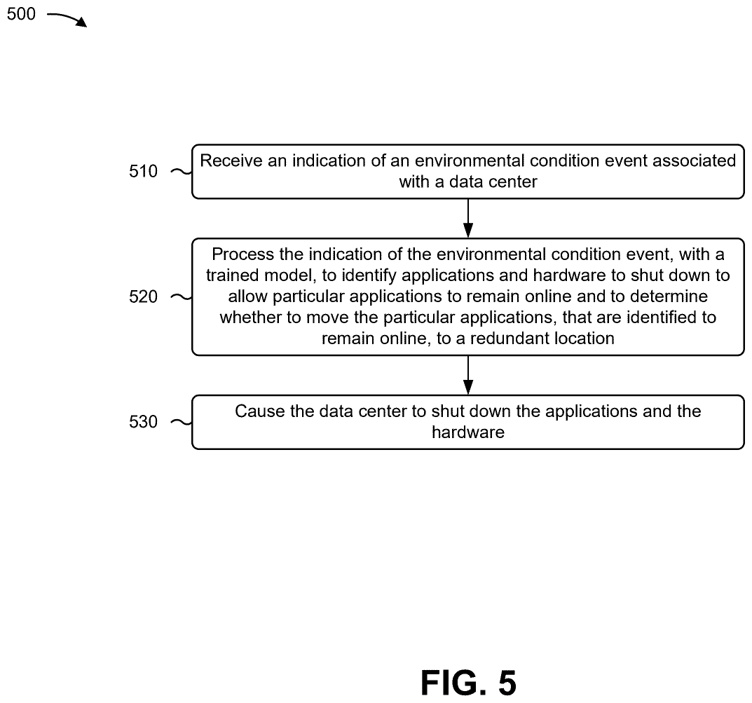

FIG. 5 depicts a flowchart of an example process 500 for utilizing a machine learning model to protect a data center during an environmental failure. In some implementations, one or more process blocks of FIG. 5 may be performed by a device (e.g., the control system 105). In some implementations, one or more process blocks of FIG. 5 may be performed by another device or a group of devices separate from or including the device. Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving an indication of an environmental condition event associated with a data center (block 510). For example, the device may receive an indication of an environmental condition event associated with a data center, as described above.

As further shown in FIG. 5, process 500 may include processing the indication of the environmental condition event, with a trained model, to identify applications and hardware to shut down to allow particular applications to remain online and to determine whether to move the particular applications to a redundant location (block 520). For example, the device may process the indication of the environmental condition event, with a trained model, to identify applications and hardware to shut down to allow particular applications to remain online and to determine whether to move the particular applications to a redundant location, as described above.

As further shown in FIG. 5, process 500 may include causing the data center to shut down the applications and the hardware (block 530). For example, the device may cause the data center to shut down the applications and the hardware, as described above.

In some implementations, process 500 includes causing the data center to move the particular applications, that are identified to remain online, to the redundant location. In some implementations, process 500 includes receiving another indication of a power failure event associated with the data center; processing the other indication of the power failure event, with the trained model, to identify other applications and other hardware to shut down to reduce power consumption and allow the particular applications to remain online and to determine whether to move the particular applications, that are identified to remain online, to the redundant location; and causing the data center to shut down the other applications and the other hardware. In some implementations, process 500 includes causing the data center to move the particular applications, that are identified to remain online, to the redundant location.

In some implementations, process 500 includes receiving data center data associated with the data center; processing the data center data, with the trained model, to identify redundant applications and hardware to shut down to reduce power consumption during low traffic periods; and causing the data center to shut down the redundant applications and hardware during low traffic periods. In some implementations, the data center data includes data identifying one or more of environmental conditions, server conditions, server capacities, power consumption, heat output, security components, particular application utilization, redundant location capacity, or network performance KPIs associated with the data center.

In some implementations, process 500 includes receiving another indication of an application that has been compromised in the data center; processing the other indication of the application that has been compromised, with the trained model, to identify a particular redundant location for executing the application; and causing the data center to move the application to the particular redundant location.

In some implementations, process 500 includes receiving data center data associated with the data center; receiving external environmental data associated with the data center; and training a machine learning model, with the data center data and the external environmental data, to generate the trained model. In some implementations, process 500 includes initiating a shutdown sequence for the data center based on the indication of the environmental condition event. In some implementations, the shutdown sequence causes the data center to shut down particular components, migrate particular traffic to backup locations, and reduce power consumption. In some implementations, process 500 includes identifying particular components of the data center to shut down during the shutdown sequence, identifying particular traffic to migrate to backup locations during the shutdown sequence, and identifying one or more servers to deactivate during the shutdown sequence to reduce power consumption. In some implementations, process 500 includes notifying a system administrator about initiation of the shutdown sequence for the data center.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of”' a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, an indication of an environmental condition event associated with a data center;
processing, by the device, the indication of the environmental condition event, with a trained model, to identify applications and hardware to shut down to allow particular applications to remain online and to determine whether to move the particular applications, that are identified to remain online, to a redundant location; and
causing, by the device, the data center to shut down the applications and the hardware.

2. The method of claim 1, further comprising:
causing the data center to move the particular applications, that are identified to remain online, to the redundant location.

3. The method of claim 1, further comprising:
receiving another indication of a power failure event associated with the data center;
processing the other indication of the power failure event, with the trained model, to identify other applications and other hardware to shut down to reduce power consumption and allow the particular applications to remain online and to determine whether to move the particular applications, that are identified to remain online, to the redundant location; and
causing the data center to shut down the other applications and the other hardware.

4. The method of claim 3, further comprising:
causing the data center to move the particular applications, that are identified to remain online, to the redundant location.

5. The method of claim 1, further comprising:
receiving data center data associated with the data center;
processing the data center data, with the trained model, to identify redundant applications and hardware to shut down to reduce power consumption during low traffic periods; and
causing the data center to shut down the redundant applications and hardware during low traffic periods.

6. The method of claim 5, wherein the data center data includes data identifying one or more of environmental conditions, server conditions, server capacities, power consumption, heat output, security components, particular application utilization, redundant location capacity, or network performance key performance indicators associated with the data center.

7. The method of claim 1, further comprising:
receiving another indication of an application that has been compromised in the data center;
processing the other indication of the application that has been compromised, with the trained model, to identify a particular redundant location for executing the application; and
causing the data center to move the application to the particular redundant location.

8. A device, comprising:
one or more processors configured to:
receive an indication of an event associated with a data center,
wherein the event is an environmental condition event or a power failure event associated with the data center;
process the event, with a trained model, to identify applications and hardware to shut down to allow particular applications to remain online and to determine whether to move the particular applications to a redundant location; and
cause the data center to shut down the applications and the hardware.

9. The device of claim 8, wherein the one or more processors are further configured to:
receive data center data associated with the data center;
receive external environmental data associated with the data center; and
train a machine learning model, with the data center data and the external environmental data, to generate the trained model.

10. The device of claim 9, wherein the data center data includes data identifying one or more of environmental conditions, server conditions, server capacities, power consumption, heat output, security components, particular application utilization, redundant location capacity, or network performance key performance indicators associated with the data center.

11. The device of claim 8, wherein the one or more processors are further configured to:
initiate a shutdown sequence for the data center based on the indication of the environmental condition event.

12. The device of claim 11, wherein the shutdown sequence causes the data center to shut down particular components, migrate particular traffic to backup locations, and reduce power consumption.

13. The device of claim 11, wherein the one or more processors are further configured to:
identify particular components of the data center to shut down during the shutdown sequence;
identify particular traffic to migrate to backup locations during the shutdown sequence; and
identify one or more servers to deactivate during the shutdown sequence to reduce power consumption.

14. The device of claim 11, wherein the one or more processors are further configured to:
notify a system administrator about initiation of the shutdown sequence for the data center.

15. A non-transitory computer-readable medium storing a set of instructions, the set of instructions comprising:
one or more instructions that, when executed by one or more processors of a device, cause the device to:
receive data center data associated with a data center;
receive external environmental data associated with the data center;
train a machine learning model, with the data center data and the external environmental data, to generate a trained model;
receive an indication of an environmental condition event associated with a data center;
process the indication of the environmental condition event, with the trained model, to identify applications and hardware to shut down to allow particular applications to remain online and to determine whether to move the particular applications to a redundant location; and
cause the data center to shut down the applications and the hardware.

16. The non-transitory computer-readable medium of claim 15, wherein the one or more instructions further cause the device to:
cause the data center to move the particular applications, that are identified to remain online, to the redundant location.

17. The non-transitory computer-readable medium of claim 15, wherein the one or more instructions further cause the device to:
receive another indication of a power failure event associated with the data center;
process the other indication of the power failure event, with the trained model, to identify other applications and other hardware to shut down to reduce power consumption and allow the particular applications to remain online and to determine whether to move the particular applications, that are identified to remain online, to the redundant location; and
cause the data center to shut down the other applications and the other hardware.

18. The non-transitory computer-readable medium of claim 17, wherein the one or more instructions further cause the device to:
cause the data center to move the particular applications, that are identified to remain online, to the redundant location.

19. The non-transitory computer-readable medium of claim 15, wherein the one or more instructions further cause the device to:
receive new data center data associated with the data center;
process the new data center data, with the trained model, to identify redundant applications and hardware to shut down to reduce power consumption during low traffic periods; and
cause the data center to shut down the redundant applications and hardware during low traffic periods.

20. The non-transitory computer-readable medium of claim 15, wherein the one or more instructions further cause the device to:
receive another indication of an application that has been compromised in the data center;
process the other indication of the application that has been compromised, with the trained model, to identify a particular redundant location for executing the application; and
cause the data center to move the application to the particular redundant location.
